(19) United States
(12) Patent Application Publication
(10) Pub. No.: US 2010/0014136 A1
(43) Pub. Date: Jan. 21, 2010

(54) Holographic Projection System Using Micro-Mirrors for Light Modulation

(76) Inventors: Ralf Haussler, Dresden (DE); Armin Schwerdtner, Dresden (DE)

Correspondence Address: Saul Ewing LLP (Philadelphia), Attn: Patent Docket Clerk, 2 North Second St., Harrisburg, PA, 17101, US

(21) Appl. No.: 12/439,193

(22) PCT Filed: Aug. 10, 2007
(86) PCT No.: PCT/EP07/58322

§ 371 Date: Aug. 14, 2009

(30) Foreign Application Priority Data
Sep. 1, 2006 (DE) 102006041875.1

(51) Int. Cl. G02B 5/32

(52) U.S. Cl. 359/15

(57) ABSTRACT

The invention relates to a holographic projection system wherein light modulator means SLM with electromechanically moved micro-mirrors modulate a light wave front LW_{mod}. According to the invention, a hologram processor HP sets micro-mirror surfaces of prior art spatial light modulator which are disposed as controllable diffraction gratings on a substrate of a control circuit, such that they reach a certain diffraction grating amplitude, by moving them continuously at right angles to the substrate, said diffraction grating amplitude being dependent on the content of a sequence of video holograms. The diffraction grating modulate a light wave which is emitted by the light modulator means and which generates illumination capable of generating interference according to a phase hologram, so that the modulated light wave is used directly for the holographic reconstruction.

### FIELD OF THE INVENTION

The present invention relates to a holographic projection system which contains light modulator means with individually controllable modulator cells in the form of electro-mechanically movable micro-mirrors, i.e. a so-called electro-mechanical system (MEMS), for modulating a light wave front. The modulator cells are illuminated by light capable of generating interference, and they are coded with sequences of video holograms in order to reconstruct holographically the optical appearance of three- dimensional scenes. The system shall be used predominantly to reconstruct a moving three-dimensional scene with holographic video means in real time or at least near real time. This makes particularly great demands on the resolution and speed of the light modulator means in order to be able to realise holographic reconstructions with high resolution, brightness and contrast while there is only little local and temporary cross-talking. Because in the micro-mechanical system the electronic controllers and the modulator cells are integrated on one chip, the diagonal of the modulator surface area of the light modulator means generally measures up to a few centimetres only. To be able to present the three-dimensional scene to one or more observers at a sufficiently large viewing angle, the modulated light wave front is enlarged with the help of an optical projection system.

### BACKGROUND OF THE INVENTION

Holographic projection systems which enlarge the light wave front are well known to those skilled in the art. For example, the applicant describes a system for the holographic reconstruction in the previous patent application DE 10 2005 023 743, which has not yet been published by the time the present application was filed.

That application describes a projection system where sufficiently coherent light illuminates a micro spatial light modulator. The device contains a projection system with two projection means, which project the coherent light into an at least one visibility region. Thereby a first projection means projects a hologram, which is encoded on the light modulator, in an enlarged manner on to a second projection means, which is larger than the first projection means. The larger projection means projects a spatial frequency spectrum, a so called Fourier spectrum, of the video hologram into a visibility region. By way of optical magnification of the coded hologram, which carries the holographic information, on to the second projection means, the reconstruction of the scene is focused on to the eyes of one or multiple observers in an enlarged reconstruction space. The visibility region is thus the image of the used diffraction order of the video hologram. The first projection means projects the entire light modulator on to the second projection means.

The second projection means here represents an exit of the projection system to each visibility region and defines a frustum-shaped reconstruction space. The scene is reconstructed in this reconstruction space. The light modulator can be encoded such that the reconstruction space continues behind the second projection means. The observer can thus watch the reconstructed scene in the large reconstruction space located at the visibility region.

Methods for modulating the light wave front in a holographic projection system with the help of either liquid crystal light modulators or digital micro-mirror devices (DMD) are known. Because of their limited operating speed, among other reasons, liquid crystal light modulators exhibit grave disadvantages, used in real-time applications, e.g. temporal multiplexing of images of a scene. They will therefore not be considered any further below.

A known type of digital micro-mirror devices, so-called DMD modulators, contains for each pixel of the light modulator a microscopically small tilting micro-mirror which tilts periodically like a seesaw between two reflection directions. The projection system only uses the reflected light of one of the two reflection directions for image reproduction. This means that the spatial modulation of the light is performed by way of pulse width modulation; only the light intensity can be controlled. The application in a holographic projection system is known for example from US patent application US 2002/176127 titled “Digital micro-mirror holographic projection”. Because DMD modulators realise neither amplitudes nor phases of light directly they are suitable to only a limited extent for use in holography, because they allow limited temporal coherence only.

Furthers for a two-dimensional image reproduction with a projection system, various reflective light modulators with controllable light diffraction gratings are known. They contain for each pixel several elongated micro-mirrors which are arranged to form a diffraction grating and which are deflected mechanically by applying a control voltage. The image information is thereby converted into the corresponding phase modulation of a light wave. The projection system then transforms the phase modulation of the light waves into light intensity modulation in an observer space, e.g. by repressing the un-modulated light and transmitting the modulated light to the observer. The advantages of such modulators are a favourable energy balance for controlling by pixel miniaturisation and an extremely large number of pixels which can be realised.

In these micro-modulators, each modulator cell contains ultra-fine micro-mirrors, more precisely in alternate arrangement fix micro-mirrors and movable micro-mirrors in the form of small reflective ribbons which are deflected across the substrate. In the literature these light modulators are called “grating electromechanical systems” (GEMS™, Eastman Kodak Company) or “grating light valves” (GLV™, Silicon Light Machines Inc.) A mechanical deflection of selected ribbons or a deflection of individual sections of the ribbons at right angles to the substrate modifies the optical path lengths of parts of the reflected wave front. This causes the wave front to be diffracted.

Now, it will be shown in compact form which of the many publications best describes the technological background of the light modulator means used for the invention.

A controllable light modulator with diffraction grating light valves, which is used in conventional projection systems for the modulation of an incident light beam with a defined distance for forming a two-dimensional image, is known from European patent EP 1 090 322 B1 titled “Method and apparatus for modulating an incident light beam for forming a two-dimensional image”. Each modulator cell is designed as a diffraction grating and contains a plurality of deformable oblong elements with a reflective surface, said elements being suspended at their ends on a substrate in parallel arrangement. Every second reflective element of a modulator cell can be deformed by mechanical diffraction grating amplitude towards the substrate, but without contacting the substrate, when applying a control voltage. As the distance between the elements and the substrate is large compared with the grating amplitude, hysteresis and other forms of control bias are avoided when deflecting the elements.

A defined initial voltage as a control voltage holds all reflective elements of a modulator cell in a common idle position at a uniform distance to the substrate. Thereby, the cell as a whole reflects a light wave without any diffraction, i.e. without applying control voltage it functions as a plane mirror.

In contrast, if the control voltage deforms every other reflecting element, a cell will diffract the light wave. During that deformation, the control voltage presses an approximately flat central section of the elements with a grating amplitude of λ/4 towards the substrate. The difference of the path lengths of the deformed and non-deformed reflecting elements is then half the wavelength, which due to the effects of interference causes the incident light wave to be diffracted into the positive and the negative first diffraction order. A fine adjustment of the grating amplitude is provided by modifying the control voltage.

A focusing lens collects the light diffracted by the diffraction gratings and projects it in the form of discrete image light points of a two-dimensional image to an observer. Although the changing grating amplitude affects the phase of parts of the light waves, even in these conventional operating mode of modulators with controllable diffraction gratings the ratio of reflection and diffraction in a defined period of time determines the display intensity of each modulator cell.

According to an embodiment, the projection system contains slot diaphragms which only allow diffracted light of the first diffraction orders to exit the system. In another embodiment, fix reflectors, light shields or shutters are disposed on the ends of the reflecting elements. These components ensure that the two-dimensional image is exclusively generated by the approximately flat centre sections. The modulator thereby sets clearly defined phase relations by lowering the micro-mirrors from their hold position.

European patent EP 1 122 577 B1 titled “Spatial light modulator with conformal grating device” also describes a controllable mechanical diffraction grating light modulator with micro-mirrors. Each modulator cell contains at least one elongated elastic ribbon with reflective surfaces. The ribbon is suspended at its ends and by at least one intermediate support such that fixed and mechanically flexible sections of the ribbon alternate so to form a controllable diffraction grating. The phase grating is created by elastic deformation of the flexible sections, i.e. by deflection towards the substrate by a fourth of the light wavelength λ/4, such that a diffraction grating lies along the ribbons. The modulator works digitally. It has a diffracting operating state, where the deformable sections of the ribbons are drawn towards the substrate so to form a diffraction grating, and a reflecting operating state, where the ribbons reflect light like a plane mirror. Most of the light is diffracted into light of the positive and the negative first and second diffraction orders. Depending on the optical design of the projection system, one or more of these diffraction orders can be used optically. In applications which require great contrast and performance, the reflected and non-diffracted light should be blocked by the system. The reflection direction of the non-diffracted light will be referred to as diffraction order D₀ below.

A display which takes advantage of the known diffraction grating light modulator is known both from EP 1 193 525 titled “Electromechanical grating display system with spatially separated light beams” and from the international patent application WO 98/41893 titled “Display device incorporating one-dimensional high-speed grating light valve array”. The modulator cells of those two known solutions reflect or diffract light according to image information, said light then failing into certain separate directions. The light is directed on to the modulator cells at an almost right angle through an own lens system and a tilted mirror, which is disposed on the optical axis of the projection system.

An optical system, which contains the tilted mirror, the lens and shutters, separates at least the non-diffracted light from diffracted light, whereby an image becomes visible via a display screen. This way the image is reproduced via the screen at a speed that cannot be perceived by the human eye.

In the applications diffraction grating light modulators described above, the light intensity of the modulated wave is adjusted in the image projection system by way of pulse width modulation through the duty factor. An image signal switches each modulator cell between the functions of a diffraction grating and of a reflecting mirror, and an optical projection system projects the modulator cells into a screen. Because shutters or semi-transmissive mirrors block non-diffracted light of the diffraction order D₀, or reflect it back to the illumination, the modulator cell appears dark if all ribbons of that cell are set such that they all have the same distance to the substrate.

In contrast, if a phase profile with different distances to the substrate is set on the ribbons of a cell, that modulator cell appears bright.

However, there are also other known solutions, where the light intensity of the modulator cells is set by continuously adjusting a diffraction efficiency. For example, European patent application EP 1 296 171 titled “Electro-mechanical grating device having a continuously controllable diffraction efficiency” describes a modulation referred to as intensity modulation, where the diffraction efficiency of a modulator with diffraction grating is continuously controlled through the grating amplitudes. For this, for each modulator cell the grating amplitude can be adjusted continuously between a point with low or no diffraction intensity and a point with maximum diffraction intensity. The amplitude used for a maximum diffraction intensity is then a fourth of the used light wavelength at most. In contrast to the grating structures described above, here two sets of deformable elongated elements are interlaced in a comb-like manner and suspended—without intermediate supports—at their ends on a duct such that these sets can be deformed against each other alternately.

### DISCLOSURE OF THE INVENTION

It is the object of the present invention to find among the known light modulator means for modulating a light wave front with the help of discretely controllable modulator cells which have electromechanically movable micro-mirror surfaces those types which if used in a holographic projection system provide a high-quality holographic representation, in particular sufficient resolution and brightness if there is a rapidly changing sequence of video holograms of the moving three-dimensional scene. At the same time, the invention aims to identify the technical means which are necessary to take advantage of such light modulator means in a projection system for a high-quality holographic reconstruction, in particular in order to realise a high resolution and low noise while there is a rapidly changing sequence of video holograms.

The invention is based on the idea to serially encode known spatial light modulator means having modulator cells with phase holograms which correspond with a sequence of video holograms of a moving scene. Each modulator cell has controllable diffraction gratings with micro-mirror surfaces which are integrally formed with the substrate of at least one control circuit. The control circuit moves the micro-mirror surfaces perpendicular to the substrate with mechanical diffraction grating amplitudes, which depend on the content of the encoded phase hologram. For a light wave which is emitted by the modulator cells and which generates illumination capable of generating interference, the modulator cells thus act as controllable diffraction gratings with a locally continuously adjustable phase modulation Thereby the diffraction gratings of the light modulator means modulate and diffract the emitted light wave, thus generating diffracted and phase-modulated light wave portions. These light wave portions are used for holographic reconstruction.

A technical problem when realising such light modulators, however, are the fix micro-mirror surfaces of the controllable diffraction gratings, which are disposed between the moved micro-mirror surfaces. Independent of the amplitude of the moved micro-mirror surfaces, they cause a permanent portion of non-diffracted light in the diffraction order D₀. Like in conventional two-dimensional displays which use the above-mentioned light modulators, that portion of light would disturb the holographic reconstruction as it carries no holographic information. This is why the projection system must separate the diffracted light portions of the modulated emitted light wave with the help of prior art separation means, such that only those light wave portions which carry holographic information leave the system through an exit path for reconstructing.

According to the invention, the optical system contains Fourier transformation means which transform the phase hologram which is encoded on the modulator cells. A spatial frequency spectrum of the modulated light wave of the phase hologram appears in a first Fourier plane, and said spectrum containing the diffracted and phase-modulated light wave portions and un-modulated light in locally separate spatial ranges.

Both the separation means and optical magnification means are disposed in the Fourier plane such that the optically separated, phase-modulated light waves of the phase hologram, which is fully separated by the separation means from only one diffraction order, is projected in an enlarged manner to a display screen.

The display screen is a focusing optical device, so that it only focuses the separated, phase-modulated light, which carries the holographic information of the phase hologram, into visibility regions in a reconstruction space in front of the eyes of observers. Thereby phase-modulated light wave portions from the separated diffraction order reconstruct a light wave front from object light points by way of interference. The light wave front conforms optically to the three-dimensional scene and propagates towards the observer eyes.

The construction of the display screen can use a focusing lens or a concave mirror. In order to achieve a great usable viewing angle when watching the reconstruction, the display screen preferably has a screen extent which is as large as possible. The best and cost-efficiently embodiment of the display screen uses a concave mirror.

The phase modulation behaviour of the above-mentioned diffraction grating light modulators is particularly well suited for the holographic reconstruction of three-dimensional scenes, because of the fast operating speed of the micro-mirrors and thanks to the fact that a great resolution can be realised inexpensively.

Another problem is the fact that the prior art modulators for a two-dimensional video display are dimensioned mechanically such that they can only realise a limited maximal diffraction grating amplitude of a quarter of the light wavelength used. The modulator cells are thus only able to set a phase value in a range of between a minimum value φₘᵢₙ=0 and a maximum value φₘₐₓ=π in the modulated wave. This range of phase values only covers half a light wavelength in the modulated wave. For an error-free holographic reconstruction with the help of phase holograms, all phase values of the phase value range which lies in the second half of the light wavelength are missing. They can only be set by doubling the maximum grating amplitude.

Doubling the maximum grating amplitude can be. achieved for example by illuminating light modulators which are designed for a wavelength in the infrared range with visible light of half the wavelength for a holographic reconstruction.

Generally, the known light modulators can also be designed for the doubled grating amplitude. However, this requires a cost-intensive re-design of a known conventional modulator. Moreover, numerous mechanical measures for an optimisation of the dynamic behaviour make doubling the grating amplitude difficult to achieve. A linear phase modulation is difficult at higher grating amplitudes because of an increasing non-linear movement which causes the deflection behaviour of the deformed grating elements, and because of a rise in the control voltage required. A drift due to ambient conditions, in particular fluctuating temperatures, or creeping of the micro-mirrors can deteriorate the quality of the representation.

In order to circumvent those disadvantages, an extended embodiment of the invention relates to a holographic projection system wherein the light modulator means contain two spatial grating light modulators, which are disposed optically in series, while the general idea of the invention is maintained. These grating light modulators are coupled through an optical projection system and realise in this conjunction a continuous phase modulation over the entire phase range which lies within the light wavelength.

A further embodiment of the invention identifies technical features with the help of which mechanical biases in the analogue deflection of the mirrors can be kept linear. The mechanical lowering of each ribbon is thereby measured and controlled dynamically.

### BRIEF DESCRIPTION OF THE DRAWINGS

Now, the present invention will be described in detail with the help of embodiments.

FIG. 1 is a top view of a projection system according to the present invention with a diffraction grating light modulator containing modulator cells in the form of controllable diffraction gratings for spatial light modulation and a focusing lens as display screen.

FIG. 2 shows details of a single modulator cell of a prior art diffraction grating light modulator.

FIG. 3 is a side view showing another embodiment of the projection system shown in FIG. 1, with a concave mirror as display screen and a spatial frequency filter in the image plane of the diffraction grating light modulator.

FIG. 4 shows an extended embodiment of the invention, where the light modulator means contain two spatial diffraction grating light modulators which are optically disposed in series, and which in this conjunction realise the required full phase modulation range.

### DETAILED DESCRIPTION OF THE PREFERRED EMBODIMENTS

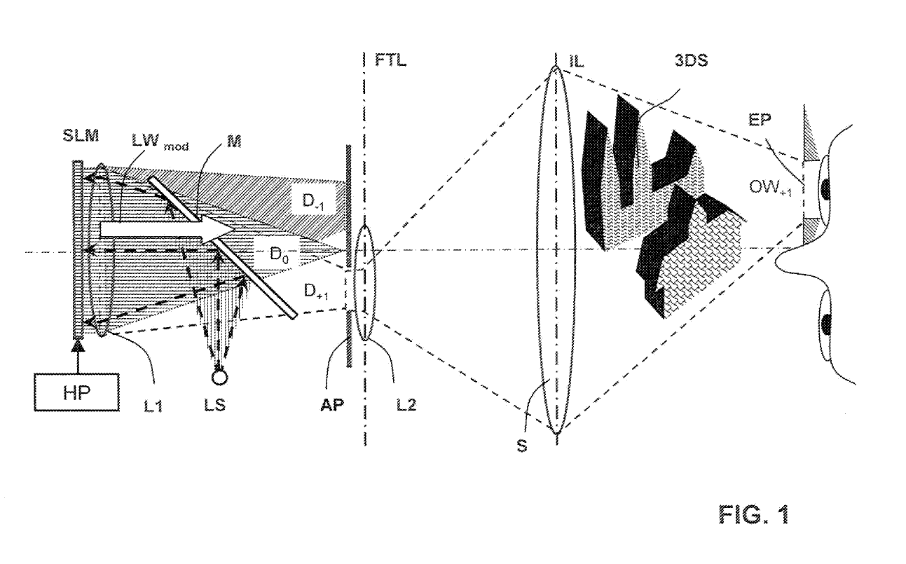

FIG. 1 shows a holographic projection system with light modulator means, which contains a diffraction grating light modulator SLM. The light modulator SLM has a modulator surface with modulator cells, which are integrally formed on the substrate of a control circuit in the form of a micro-mirror structure, and which form separately controllable diffraction gratings. In the present case, the light modulator SLM is one of the prior art diffraction grating light modulators with a plurality of electromechanically movable micro-mirror surfaces for each modulator cell, said surfaces being controlled with the help of holographic input information.

In order to achieve a high-quality holographic reconstruction, it must be possible to lower the diffraction grating amplitude A of the micro-mirrors of each modulator cell at least up to half a light wavelength λ. Because the light modulator SLM operates in the reflective mode, the modulator cells can thus set any desired local phase value within the entire light wavelength λ.

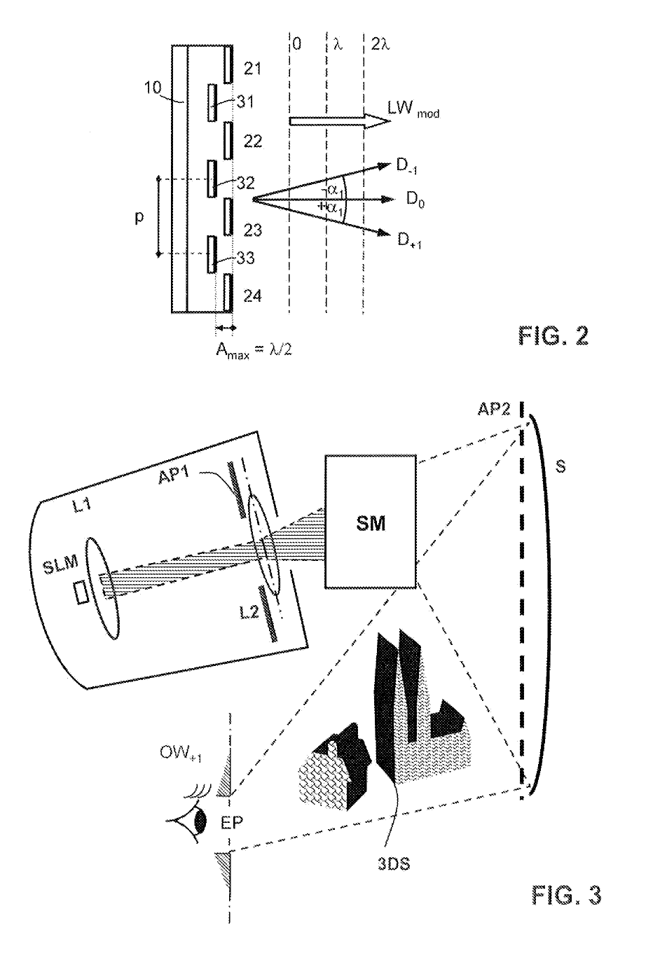

A single modulator cell of such a modulator is shown schematically for example in FIG. 2. Each cell contains fix micro-mirror surfaces 21, 22, 23 and 24 and micro-mirror surfaces 31, 32 and 33 which can be lowered continuously over a substrate 10 up to a maximum diffraction grating amplitude Aₘₐₓ of λ/2 by applying a control voltage.

In this type of diffraction grating light modulator, all modulator cells are arranged in a single row. A prior art scanner device, which generates the cross-sectional area of the modulated light wave front line by line sequentially, must be used in order to modulate the area of a light wave front. A detailed description of such line scanners is omitted in this application because their design and function are generally well known. The line scanner can for example be a mechanically tilted mirror; it is shown in FIG. 3 as box SM.

In the present embodiment according to FIG. 1, an illumination device LS illuminates the micro-mirror structure with light of a defined wavelength λ, which is capable of generating interference. A semi-transmissive tilted mirror M, which is disposed on the optical axis, preferably directs the light towards the micro-mirrors perpenticular to the modulator surface. This means that in the embodiment the illumination device LS and the semi-transmissive mirror M are arranged in relation to the light modulator SLM such that a light wave propagates mainly along the lowering direction of the diffraction gratings of the light modulator SLM. By a lowering movement of up to half the light wavelength λ/2, the movable micro-mirror surfaces 31, 32, 33 thus realise the desired phase modulation of a light wave LW_{mod}, which propagates away from the light modulator SLM, and which, as shown in FIG. 2, contains beside other higher diffraction orders mainly light portions of the positive and negative first diffraction orders D₋₁ and D₊₁, and non-diffracted light D₀. Because higher diffraction orders cannot be used for realising the invention, they are not shown in FIGS. 1 and 2, so to maintain a certain clarity of the diagrams.

Each cell of the light modulator SLM is connected with a separate exit of a hologram processor HP which, depending on the content of a sequence of video holograms, provides the discrete values of a holographic information for a video hologram, which was specifically calculated as a phase hologram in the present case. The calculation of such a phase hologram from existing information about a three-dimensional scene is known from various publications and will therefore not be detailed any further in this application.

Like conventional two-dimensional displays, the present invention also requires separation means such as a spatial freqency filter or spatial blocking means in order to remove parastic light portions from the modulated light wave. These means must effectively prevent non-diffracted light from exiting the projection system towards the observer. In contrast to the prior art solutions, only that light wave portion diffracted and modulated by the micro-mirror surfaces of the diffraction gratings which lies within one single diffraction order can be used for the holographic reconstruction. If an observer also sees light of other diffraction orders, the observer will see multiple reconstructions of the three-dimensional scene.

According to the invention, the optical system is therefore designed such that the system only uses the light wave portion which is diffracted and phase-modulated by the light modulator SLM for reconstruction; this is achieved by disposing focusing means and light separation means in a certain arrangement.

In order to achieve this, the projection system contains Fourier transformation means, for example a focusing lens L1, which transforms the modulated light wave into a Fourier plane FTL, so that the Fourier spectrum of the phase hologram with an arrangement of all parasitic light diffraction orders of the modulated light wave LW_{mod} lies in that plane.

According to an embodiment of the invention, a spatial frequency filter like a aperture mask AP having an aperture which let pass the wanted wave portion is disposed in the Fourier plane FTL or at least near the Fourier plane. This frequency filter is shaped geometrically such that it exclusively and, for the benefit of an error-free reconstruction, fully transmits the modulated light of the positive first diffraction order D₊₁ to the light exit of the projection system. Generally, the aperture can also be disposed such that it separates the modulated light of the negative first diffraction order D₋₁ instead of the modulated light of the positive first diffraction order D₊₁. Other, diffraction orders are less suitable for holographic reconstruction due to their low light intensity.

Further, in the Fourier plane FTL there is also disposed an optical magnification means in the form of a projecting lens L2, which projects in an enlarged manner on to a large-surface display screen S the phase-modulated light wave portions of one diffraction order, which are separated by the aperture mask AP. The display screen S can, in the present case, either be a focusing lens or, preferably, a focusing mirror.

The display screen S projects the separated phase-modulated light wave portion carrying the separated diffraction order of the modulated wave into an visibility region OW, which lies in front of each eye position EP of at least one observer eye. Like for the display of two-dimensional images, the display screen S has a much greater cross-section than a visibility region for the benefit of a large viewing angle.

The phase hologram is encoded on the light modulator SLM such that the reconstruction of the three-dimensional scene is generated in the space between the display screen S and the eye position EP.

The holographic projection system shown in FIG. 1 thus takes advantage of the basic principle of a projection system which has already been described by the applicant in the earlier patent application DE 10 2005 023 743. FIG. 1 shows with the help of the diffraction orders D₋₁, D₊₁ and D₀ that the light modulator SLM only realises a controllable diffraction of the emitted light wave in the horizontal direction. This means that the light modulators used only modulate the light wave in the direction of a line, so that a holographic reconstruction can only be generated line-wise.

The holograms must therefore be encoded as one-dimensional line holograms, which are projected on to the eye position line by line with the help of known wave deflecting means, as is common practice in video processing. One-dimensional line holograms only exhibit parallax information for the observer eyes in the horizontal direction only. The technology needed for this and its advantages are well known. There will be no further explanations on that technology in this description, because it is not an object of the invention.

In the contrast to prior art solutions, in the present case the tilted mirror M must be of a semi-transmissive type, because a conventionally used, fully reflective tilted mirror M, which owing to its function must be disposed on the optical axis, i.e. on the optical path of the system, would also shade important modulated light portions of the diffraction order D₊₁ used, which are needed for an error-free reconstruction.

The geometry and dimension of the tilted mirror M must be designed such that with its position in the optical path of the emitted light wave it exhibits identical optical properties for all portions of the used diffraction order D₊₁ of the light wave LW_{mod}, such that all portions of the separated wave are optically affected in the same way and coherence is maintained when passing through the mirror M.

It will appear to those skilled in the art that the light which is capable of generating interference can also be directed towards the micro-mirror structure differently, e.g. through a selective beam splitter and/or with a directly radiating light source system which is disposed at an angle to the direction of deflection. This requires the optical components to be adapted in various respects, but this is not object of this invention. For example, if the light is directed towards the micro-mirror surfaces directly and at an angle, the micro-mirror controller must lower the individual mirror surfaces 31 . . . 33 at different diffraction grating amplitudes.

In a continuation of the invention, further separation means can be disposed also in the image plane of the light modulator SLM.

The described projection system functions as follows

The illumination device LS illuminates the light modulator SLM, and the focusing lens L1 projects the illumination device LS into the Fourier plane FTL. The aperture mask AP and the magnifying lens L2 are disposed near that Fourier plane. Because the light modulator SLM is disposed in the immediate vicinity of the focusing lens L1, the Fourier transform of the light modulator SLM also lies in the image plane of the illumination device LS. A region with non-diffracted light, the diffraction order D₀, which is reflected by the fix micro-mirror surfaces 21 . . . 24, is in this plane located where the image of the illumination device LS lies.

As shown in FIG. 2, the diffraction order D₊₁ is emitted at an angle of +α₁, and the diffraction order D₋₁ at an angle of −α₁. The angles +α₁ depend on the distance p of the centres of two adjacent lowerable micro-mirror surfaces and the light wavelength λ; they can be expressed by the equation

±α₁=±λ/p (1)

Other diffractions of the light also appear in the form of parasitic diffraction orders, but will not be considered any further in the present invention.

If all movable micro-mirror surfaces are lowered by the same amplitude, the diffraction in the diffraction orders D₊₁, D₋₁ occurs at the angle defined by the equation (1), independent of the amplitude itself.

In contrast, if the movable micro-mirror surfaces are lowered by different amplitudes, the light of the first diffraction orders D₊₁, D₊₁ is distributed to angular ranges around ±α₁, i.e. from αₙ=0.5 λ/p to 1.5 λ/p.

One of these angular ranges can be used for a holographic projection device. The light in the other angular ranges must be separated.

In FIG. 1 the aperture mask AP is disposed such that the non-diffracted light D₀ and the diffracted light of the diffraction order D₋₁ is blocked and the diffracted light of the diffraction orders D₊₁ is transmitted to the system exit.

When designing the projection system, importance must be attached to the fact that the light of the diffraction orders D+₁ does not overlap with light of an adjacent diffraction order, i.e. the non-diffracted light D₀ or light of a parasitic diffraction order.

Depending on the distance d of its location, the Fourier plane FTL, to the light modulator SLM, the aperture mask AP must at the same time be designed and disposed such that it has a transmission range from 0.5 λ*d/p to 1.5 λ*d/p only.

The magnifying lens L2 projects the light modulator SLM on to the display screen S, and the display screen S projects the apertures of the aperture mask AP to the eye position EP. The image of the aperture of the aperture mask AP forms at the eye position EP a visibility region OW, where the holographically reconstructed three-dimensional scene 3DS can be watched. Attention must be paid to the fact that the observer only sees light of one diffraction order in the visibility region, because otherwise disturbing multiple reconstructions of the three-dimensional scene would become visible.

FIG. 3 shows another embodiment of the inventive projection system, with a concave mirror screen S and a spatial frequency filter in the form of a aperture mask A2 in the image plane of the light modulator SLM.

The first aperture mask A1 is optional and lies in the Fourier plane. It only separates the parasitic diffraction orders there. A sufficient suppression of parasitic diffraction orders can also be achieved by a high fill factor of the light modulator SLM. The magnifying lens L2 projects the light modulator SLM into the plane of the concave mirror screen S. The aperture mask A2 is disposed in that plane. It has a spacing which is identical to the enlarged centre distance p of the light modulator SLM, which is projected in an enlarged manner. The aperture mask A2 is positioned such that the movable micro-mirror surfaces 31 . . . 33 are projected on to the transparent sections of the aperture mask A2 and the fix micro-mirror surfaces 21 . . . 24 are projected on to the absorbing sections of the aperture mask A2. Thanks to this arrangement, the light reflected from the fix surfaces 21 . . . 24 is blocked. The light modulated by the movable surfaces reconstructs the scene, which can be watched at the eye position in the visibility region OW.

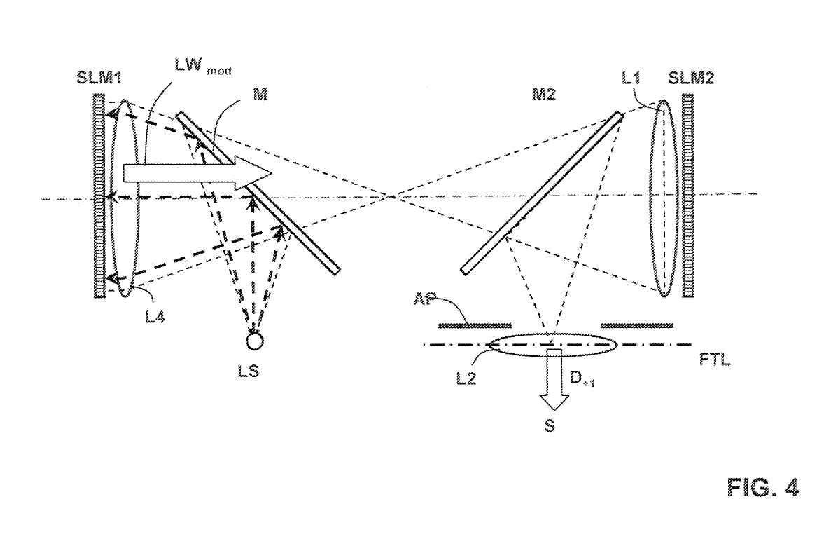

Another preferred embodiment of the invention shows FIG. 4. The light modulator means contains a first diffraction grating light modulator SLM1, which is projected by projection means, here the focusing lens L1 and a second focusing lens L4, on to a second diffraction grating light modulator SLM2, which is disposed opposite. The light modulators SLM1 and SLM2 are of identical design and are aligned such that the path lengths of the emitted modulated light wave are series-connected optically and that, in their conjunction, they realise all desired phase modulation values. The phase can thus also be modulated up to a maximum phase angle φₘₐₓ2π, even if each of the light modulators SLM1 and SLM2 only realizes a small diffraction grating amplitude. For example, if the light modulators SLM1 and SLM2 are of a conventional type for two-dimensional devices so that they have a maximum diffraction grating amplitude of a quater of the light wavelength and thus has a maximum phase angle φₘₐₓ=π only.

The light modulators SLM1 and SLM2 are preferably disposed such that they face each other, where the second light modulator SLM2 lies in the image plane of the first light modulator SLM1.

In the optical path between the two light modulators SLM1 and SLM2 there are disposed the first semi-transmissive mirror M for coupling the light capable of generating interference emitted by the light source LS on to the diffraction grating light modulator SLM1, and a second semi-transmissive mirror M2 for uncoupling the modulated light wave LW_{mod} from the diffraction grating light modulator SLM2 on to the magnifying lens L2 of the projection device. In this embodiment of the invention the aperture mask A known from FIG. 1, an image of the light source LS and the Fourier transform FTL of the light modulator means, i.e. of both light modulators SLM1 and SLM2, all lie in the plane of the magnifying lens L2.

Another improvement of the invention relates to the continuous movement of the micro-mirrors. The desired phase in the light wave LW_{mod} must be set very precisely in order to achieve a high reconstruction quality. The lowering amplitude of each micro-mirror is controlled through a control voltage applied between the mirror and the substrate. If the micro-mirrors are controlled with the help of a calibration table, without measuring and controlling the actual deflection, effects such as hysteresis, ageing, drift, creeping etc. may occur and lead to phase errors. This is why the actual deflection is preferably measured and controlled.

A mechanical system which comprises a micro-mirror surface and the substrate represents a plate capacitor with a capacity that depends on the distance between the ribbon and the substrate. In an ideal plate capacitor with two plane parallel plates of same size, the capacity C is defined by the plate surface area A, the plate distance d, the material-specific relative permittivity εᵣ and the permittivity ε₀ of free space their distance C=εᵣε₀ A/d. If the true capacity is to be calculated, the exact geometry of the plates must be taken into account, e.g. the large substrate surface area 10 in relation to the smaller mirror surface areas.

According to the invention, for finding the capacity, the control voltage which is used to move the micro-mirror surfaces is superimposed by an A/C test voltage with a much higher frequency f_{C}. A computer measures the capacitive impedance X_{C} and calculates from this information the distance d to the substrate. The impedance X_{C} is defined as X_{C}=1/ωC. C and thus the distance d can be calculated based on the impedance X_{C}. The actual position of the micro-mirror surface and thus the actual phase shift can now be derived from this information.

An electronic circuit for measuring the capacitive impedance X_{C} must thus be connected to each micro-mirror surface, in order to be able to determine whether or not the mechanical position which corresponds to the desired optical phase shift has been achieved. This circuitry can be integrated on the chip of the optical light grating circuit. Importance must be attached to the fact that the measuring frequency f is much higher than the resonance frequency of the micro-mirror surfaces, so that the oscillations are sufficiently attenuated and the surface does not start to vibrate.

1. Holographic projection system using at least one, spatially modulated light wave such which reconstructs in front of the eyes of observers light points which conform with the optical appearance of a three-dimensional scene, wherein the system comprises:
a spatial light modulator means with discretely controllable modulator cells in order to modulate the light wave continuously,
a Fourier transformation means which optically transforms the modulated light wave so to achieve in a Fourier plane a Fourier spectrum of the modulated light wave and
a display screen, wherein
Each modulator cell is a controllable diffraction grating on a modulator surface and being set to a diffraction grating amplitude which depends on the content of a phase hologram, so as to phase-modulate the light wave;
Optical magnification means enlarge light portions of the light wave, which is separated by separation means exclusively from one single selected diffraction order of the light wave;
The display screen is a focusing optical device, so that a focussed, separated, modulated light wave reconstructs a scene in front of an eye position.

2. Holographic projection system according to claim 1 having discretely controllable modulator cells which are movable micro-mirror surfaces and are integrally formed with at least one control circuit.

3. Holographic projection system according to claim 1 where the display screen is a concave mirror.

4. Holographic projection system according to claim 1 where the separation means and the optical magnification means are disposed near a Fourier plane of the Fourier transformation means.

5. Holographic projection system according to claim 1 where the separation means is an aperture mask with at least one aperture exit which exclusively transmits the modulated light of the selected diffraction order towards an eye position.

6. Holographic projection system according to claim 5 which is designed in such a way that an image of the aperture exit of the aperture mask appears at the eye position.

7. Holographic projection system according to claim 2, with an optical axis which is arranged substantially perpendicular to the modulator surface, and where the light which is capable of generating interference illuminates the micro-mirror surfaces such that the modulated light wave propagates along that optical axis.

8. Holographic projection system according to claim 2 which contains a semi-transmissive tilted mirror being disposed on the optical axis, for perpendicular illumination of the micro-mirror surfaces, said mirror having at least a surface area which covers all light which lies in the optical path of the separated diffraction order.

9. Holographic projection system according to claim 2 where the electromechanically moved micro-mirror surfaces are substantially flat and are moved perpendicular to the propagation direction of the light wave.

10. Holographic projection system according to claim 1 where the Fourier transformation means is a focusing lens which is disposed near the spatial light modulator means.

11. Holographic projection system according to claim 1 where the light modulator means contain two spatial grating light modulators which are optically disposed in series, and which in this conjunction realise a continuous phase modulation.

12. Holographic projection system according to claim 11 where the grating light modulators face each other and where a projection means is disposed such that it images a first grating light modulator on to the second grating light modulator.

13. Holographic projection system according to claim 11 where with the help of another semi-transmissive tilted mirror the light wave which was modulated by the two grating light modulators is uncoupled on to the optical magnification means.

14. Holographic projection system according to claim 11 where the Fourier transformation means are disposed near the second grating light modulator, so that the phase hologram is optically transformed into a Fourier plane, which lies behind the second semi-transmissive tilted mirror, seen in the direction of light propagation.

15. Holographic projection system where the continuity of the deflection is monitored with the help of a control loop.
